(19) United States
(12) Patent Application Publication
(10) Pub. No.: US 2025/0075633 A1
(43) Pub. Date: Mar. 6, 2025

(54) TURBINE BLADE AND STEAM TURBINE

(71) Applicant: MITSUBISHI HEAVY INDUSTRIES, LTD., Tokyo (JP)

(72) Inventors: Toshiro Goto, Tokyo (JP); Toshio Watanabe, Tokyo (JP); Tadashi Takahashi, Tokyo (JP)

(73) Assignee: MITSUBISHI HEAVY INDUSTRIES, LTD., Tokyo (JP)

(21) Appl. No.: 18/594,353

(22) Filed: Mar. 4, 2024

(30) Foreign Application Priority Data
Mar. 23, 2023 (JP) 2023-047191

(51) Int. Cl. F01D 25/00; F01D 1/04; F01D 1/10

(52) U.S. Cl. CPC F01D 25/00; F01D 1/04; F01D 1/10; F05D 2260/607

(57) ABSTRACT

A turbine blade includes a blade part and an oscillator mounted on the blade part and configured to vibrate the blade part. The blade part may be formed with a hollow part, and the oscillator may be mounted inside the hollow part. The turbine blade may be a stator blade, and the blade part may include a blade and a blade ring supporting the blade.

### CROSS-REFERENCE TO RELATED APPLICATIONS

The present application claims priority to Japanese Patent Application No. 2023-047191 filed in Japan on Mar. 23, 2023, which is incorporated herein by reference in its entirety.

### FIELD

The present disclosure relates to a turbine blade and a steam turbine including this turbine blade.

### BACKGROUND

The steam turbine has a rotor inserted into an internal casing, a plurality of rotor blades disposed over multiple stages in the rotor, and a plurality of stator blades disposed over multiple stages in the internal casing, and the multistage rotor blades and stator blades are alternately disposed in the axial direction of the rotor. In the steam turbine, steam enters the internal casing and is fed into the space in which the multistage stator blades and rotor blades are disposed, thereby rotating the rotor via these multistage rotor blades and driving a generator coupled to this rotor (refer to Patent Literature 1, for example).

### CITATION LIST

### Patent Literature

Patent Literature 1: Japanese Patent Application Laid-open No. 2021-004598

### SUMMARY

### Technical Problem

The working fluid of the steam turbine is steam, and thus components contained in the steam may adhere to a blade surface as scale, which may degrade the performance of the turbine. In geothermal power generation, for example, scale adhesion in particular becomes a problem because the steam contains many minerals.

The present disclosure has been made in view of the above, and an object thereof is to provide a turbine blade and a steam turbine that can remove scale on a blade surface.

### Solution to Problem

A turbine blade according to an aspect of the present disclosure includes: a blade part; and an oscillator mounted on the blade part to vibrate the blade part.

A steam turbine according to another aspect of the present disclosure includes the above-described turbine blade.

### Advantageous Effects of Invention

The present disclosure can provide a turbine blade and a steam turbine that can remove scale on a blade surface.

### BRIEF DESCRIPTION OF DRAWINGS

FIG. 1 is a diagram of a schematic configuration of an example of a steam turbine according to an embodiment of the present disclosure.

FIG. 2 is a diagram of a configuration of a stator blade unit according to the embodiment of the present disclosure.

FIG. 3 is an enlarged view of a broken line part A in FIG. 1.

FIG. 4 is a B-B′ sectional view of FIG. 2.

FIG. 5 is an overview diagram of a second embodiment.

FIG. 6 is a sectional view of a stator blade according to Example 1 of the second embodiment of the present disclosure.

FIG. 7 is a sectional view of the stator blade according to Example 2 of the second embodiment of the present disclosure.

FIG. 8 is a sectional view of a casing according to a third embodiment of the present disclosure.

### DESCRIPTION OF EMBODIMENTS

### First Embodiment

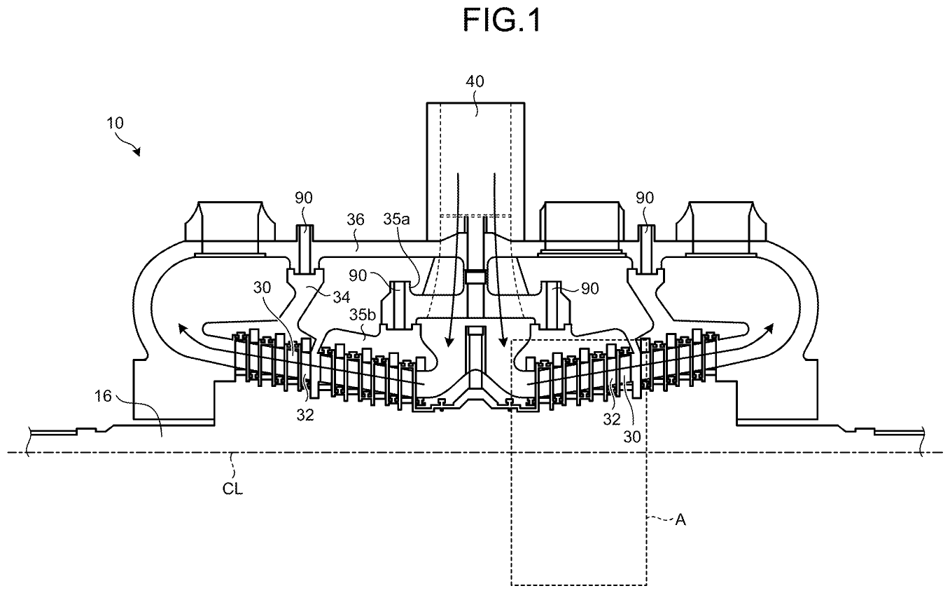

The following describes a configuration of an example of a steam turbine using FIG. 1. FIG. 1 is a diagram of a schematic configuration of a steam turbine according to an embodiment of the present disclosure.

### Steam Turbine

In this steam turbine 10 illustrated in FIG. 1, steam is supplied from the center in the axial direction of the steam turbine 10, and the steam flows toward each of both ends in the axial direction and is discharged outside from both ends in the axial direction. The steam turbine 10 has a rotor 16, a plurality of rotor blades 30 coupled to the rotor 16, an internal casing 34 disposed on the periphery of the rotor blades 30, a plurality of stator blades 32 disposed inside the internal casing 34, an external casing 36 disposed outside the internal casing 34, and a steam inlet 40 supplying steam to the internal casing 34. In the steam turbine 10, the rotor blades 30 coupled to the rotor 16 and the stator blades 32 disposed inside the internal casing 34 are alternately disposed in the axial direction of the rotor 16. The rotor blades 30 and the stator blades 32 are each disposed circumferentially in the rotation direction of the rotor 16. The internal casing 34 may be separated into an outer member 35a fixed to the external casing 36 and an inner member 35b coupled to the stator blades 32. The steam turbine 10 is provided with a fixing device 90 at each of a coupling part between the internal casing 34 and the external casing 36 and a coupling part between the inner member 35b and the outer member 35a.

In the steam turbine 10, steam supplied from the steam inlet 40 passes through the area in which the rotor blades 30 and the stator blades 32 are alternately disposed between the internal casing 34 and the rotor 16. In the steam turbine 10, the rotor blades 30 are rotated by the force of the passing steam to rotate the rotor 16. The single-dotted line in FIG. 1 is a rotary central axis CL of the rotor 16.

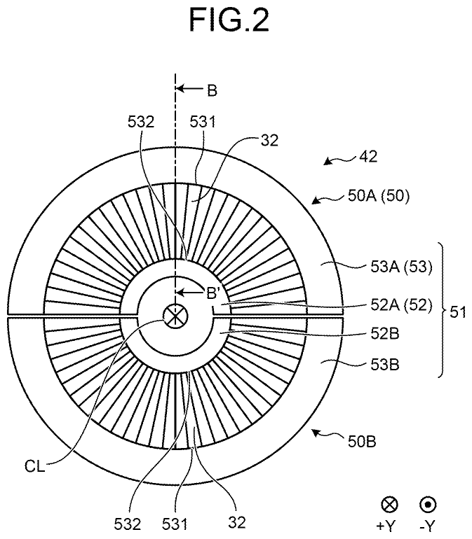

The following describes a stator blade unit according to the present embodiment using FIG. 2. FIG. 2 is a diagram of a configuration of the stator blade unit according to the present embodiment.

In the following description, the direction along the rotary central axis CL of the rotor 16 is referred to as a Y direction. The direction along the Y direction, the direction being directed upstream of the flow of the steam is defined as a-Y direction, and the direction along the Y direction, the direction being directed downstream of the flow of the steam is defined as a +Y direction. Further, the radial direction indicates a direction orthogonal to the rotary central axis CL when the rotary central axis CL of the rotor 16 is an axial direction.

### Stator Blade Unit

As illustrated in FIG. 2, the stator blade unit 42 as a blade part includes a first main body 50A and a second main body 50B having the same shape as that of the first main body 50A and being disposed facing the first main body 50A. The first main body 50A and the second main body 50B have a semiannular shape, and the center positions of these semicircles overlap with the rotary central axis CL of the rotor 16.

The first main body 50A has the stator blades 32 as blades and a blade ring 51 connected to the stator blades 32. The blade ring 51 has an inner blade ring 52A and an outer blade ring 53A. The inner blade ring 52A is provided inside the stator blades 32 in the radial direction and is connected to ends 532 of the stator blades 32 inside in the radial direction. The outer blade ring 53A is provided outside the stator blades 32 in the radial direction and is connected to ends 531 of the stator blades 32 outside in the radial direction. Similarly, the second main body 50B has the stator blades 32 as the blades and the blade ring 51 connected to the stator blades 32. The blade ring 51 has an inner blade ring 52B and an outer blade ring 53B. The inner blade ring 52B is provided inside the stator blades 32 in the radial direction and is connected to the ends 532 of the stator blades 32 inside in the radial direction. The outer blade ring 53B is provided outside the stator blades 32 in the radial direction and is connected to the ends 531 of the stator blades 32 outside in the radial direction.

The first main body 50A and the second main body 50B have the same shape, and thus the first main body 50A will be used in the following description, and the name of the first main body 50A will also be referred to as a main body 50. Similarly, in the following, the outer blade ring 53A will be referred to as an outer blade ring 53 and the inner blade ring 52A will be referred to as an inner blade ring 52.

### Blade Ring

The outer blade ring 53 and the inner blade ring 52 as blade rings are semiannular members that are hollow inside. They include a plurality of plate members. For example, the outer blade ring 53 and the inner blade ring 52 include one plate member for each face and are produced by welding the respective sides of a plurality of plate members together.

The one ends 531 of the stator blades 32 are connected to the outer blade ring 53. The other ends 532 of the stator blades 32 are connected to the inner blade ring 52. This forms the semiannular main body 50.

### Rotor Blade

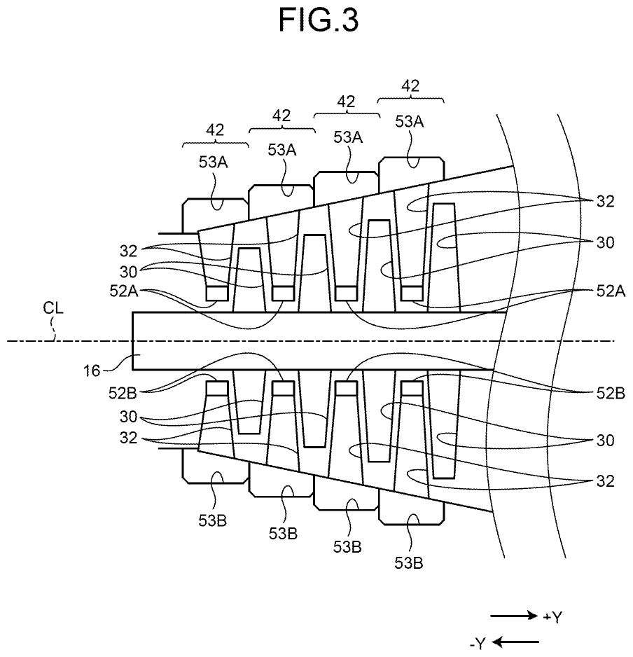

FIG. 3 is an enlarged view of a broken line part A in FIG. 1. As illustrated in FIG. 1, the rotor 16 has the rotor blades 30 and rotates about the rotary central axis CL. As illustrated in FIG. 3, a plurality of the stator blade units 42 are disposed so as to put the rotor 16 therebetween. Consequently, steam, which is working fluid of the rotor 16, passes through the space in which the rotor blades 30 and the stator blades 32 are alternately disposed toward the +Y direction.

### Stator Blade

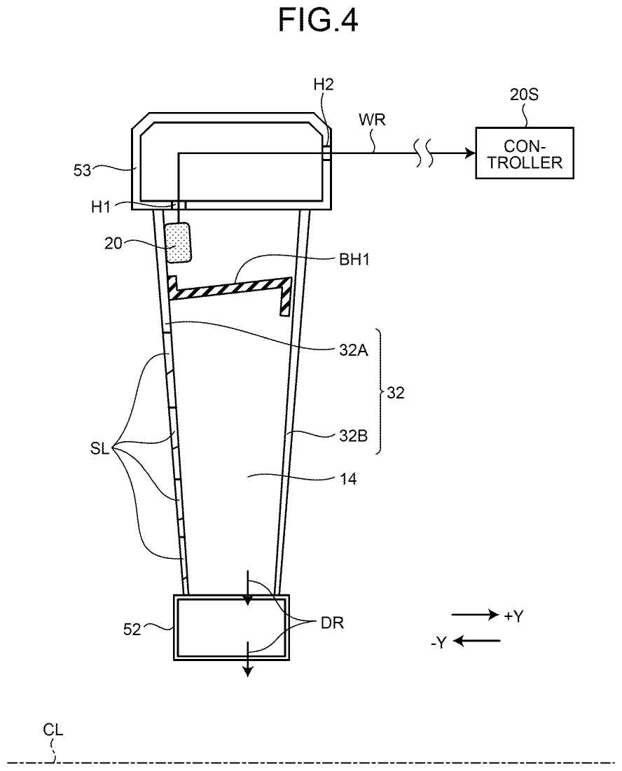

FIG. 4 is a B-B′ sectional view of FIG. 2. As illustrated in FIG. 4, the stator blade 32 in the present embodiment has a ventral member 32A and a dorsal member 32B, with a hollow part 14 as a space formed thereinside. The ventral member 32A is a member forming the surface of the stator blade 32 on the −Y direction side, and the dorsal member 32B is a member forming the surface of the stator blade 32 on the +Y direction side. The peripheries of the ventral member 32A and the dorsal member 32B are connected to each other, and part of the connected peripheries is in contact with the inner blade ring 52 and the outer blade ring 53. More specifically, the space enclosed by the outer blade ring 53, the inner blade ring 52, the ventral member 32A, and the dorsal member 32B is the hollow part 14. For example, the ventral member 32A and the dorsal member 32B may be manufactured by mating and welding the peripheries together from the front and rear directions.

The stator blade 32 may be formed with a slit SL causing the hollow part 14 to communicate with outside space. The slit SL is preferably formed in the ventral member 32A, and in the example of the present embodiment, a plurality of slits SL are formed. The slits SL have the function of taking in water (steam or water droplets) adhering by the steam as the working fluid hitting the surface of the stator blade 32 into the inside space of the stator blade 32 and removing it.

The hollow part 14 and the space inside the inner blade ring 52 are connected to each other through the part in contact with the inner blade ring 52 out of the peripheries of the ventral member 32A and the dorsal member 32B welded together. Water DR taken in from the blade surface of the stator blade 32 into the hollow part 14 through the slits SL is discharged into the hollow space inside the inner blade ring 52 through the peripheries in contact with the inner blade ring 52 out of the ventral member 32A and the dorsal member 32B welded together. The water DR discharged into the space inside the inner blade ring 52 is discharged to outside space through a drain port (not shown) of the inner blade ring 52.

The hollow part 14 and the space inside the outer blade ring 53 communicate with each other through an opening part H1. The hollow part 14 is provided with a bulkhead BH1 partitioning the inside of the hollow part 14. The bulkhead BH1 partitions the hollow part 14 into a space communicating with the slits SL and a space not communicating with the slits SL but communicating with the opening part H1 (is provided between the space communicating with the slits SL and the space communicating with the opening part H1).

### Oscillator

An oscillator 20 vibrating the stator blade unit 42 is mounted on the stator blade unit 42 as the blade part. That is, it can be said that the stator blade unit 42 and the oscillator 20 form a turbine blade.

The oscillator 20 is a device converting an electric signal into vibration. The oscillator 20 is, for example, an electrostrictive ultrasonic oscillator. The electrostrictive ultrasonic oscillator generally contains what are called piezoelectric ceramics (lead zirconate titanate (PZT) as an example), and applying a high voltage to these materials aligns the directions of ceramic crystal grains. This is a device, utilizing the property of piezoelectric ceramics that expand in the longitudinal direction when a positive voltage is applied to them and contracts (swells in the lateral direction accordingly) when a negative voltage is applied, causing “vibration” by alternately repeating this process by applying an AC signal.

The oscillator 20 may be mounted on any position on the stator blade unit 42 as the blade part, but in the present embodiment, it is mounted on the stator blade 32. When the oscillator 20 is mounted on the stator blade 32, the oscillator 20 is preferably mounted on each of the stator blades 32 provided in the stator blade unit 42.

The oscillator 20 may be mounted on the outer face of the stator blade 32, but in the present embodiment, it is mounted in the hollow part 14 of the stator blade 32. Specifically, the oscillator 20 is provided in the space partitioned by the bulkhead BH1 and communicating with the opening part H1. With this structure, the water DR having entered through the slits SL is blocked by the bulkhead BH1 and can be prevented from adhering to the oscillator 20. In the present embodiment, an electric wire WR supplying power to the oscillator 20 is connected to the oscillator 20. The electric wire WR is drawn into the space inside the outer blade ring 53 through the opening part H1 allowing the hollow part 14 and the space inside the outer blade ring 53 to communicate with each other. The electric wire WR is then drawn out to the space outside the internal casing 34 through an opening part H2 allowing the space inside the outer blade ring 53 and the space outside the internal casing 34 to communicate with each other and is connected to a controller 20S.

The oscillator 20 is mounted on the stator blade 32 by welding. Although the method of mounting is not limited to welding and may be any method, preferred is a method of mounting making the oscillator 20 and the stator blade 32 in direct contact with each other in order for the oscillator 20 to efficiently transmit the generated vibration to the stator blade 32. In the present embodiment, the oscillator 20 is mounted on an outside part in the radial direction (near the outer blade ring 53) of the ventral member 32A in the hollow part 14. The mounting position of the oscillator 20 is desirably a position upstream of the stator blade 32 (the ventral member 32A) and outside in the radial direction (near the outer blade ring 53) from the viewpoint that the position has a high flow velocity of the steam and the position is a part to which much scale adheres. By mounting the oscillator 20 on the outside position in the radial direction (near the outer blade ring 53) of the ventral member 32A, the electric wire WR to the controller 20S can be shortened. The area near the outer blade ring 53 may refer, for example, to an area that is more outside in the radial direction than the central position of the stator blade 32 in the radial direction is.

### Controller and Vibration Frequency

The controller 20S is a device supplying power to the oscillator 20. The controller 20S changes the frequency of the electric signal oscillating in the oscillator 20 to control the frequency of the vibration to be generated in the oscillator 20. To provide acceleration to the scale adhering to the blade surface and remove it, the vibration generated in the oscillator 20 is preferably vibration at a high frequency of 10 kHz or higher. It is assumed that vibration with a constant frequency alone cannot give acceleration to the scale at the nodes of a vibration mode on the blade, and the scale at the nodes may not be able to be removed. Thus, the controller 20S preferably changes the frequency of the electric signal oscillating in the oscillator 20. The frequency change of the electric signal by the controller 20S may be changed in accordance with the movable time of the turbine, or an electric signal obtained by multiplying a plurality of frequencies together may be oscillated in the oscillator 20. The controller 20S may be a stand-alone device or part of a control device of the steam turbine 10, which is not shown.

### Effects

Scale may adhere to the stator blade 32 (the blade part) of the steam turbine. In contrast, in the present embodiment, the oscillator 20 is mounted on the stator blade 32. Thus, according to the present embodiment, the scale adhering to the surface of the stator blade 32 can be removed. More specifically, in the present embodiment, the oscillator 20 can change the frequency of the vibration it generates. This can remove the scale that corresponds to the nodes of the vibration mode on the blade and cannot be removed by the vibration with a constant frequency by changing the frequency of the vibration generated in the oscillator 20.

In the first embodiment, with the stator blade 32 as the blade part, the oscillator 20 is mounted on the stator blade 32. However, this is not limiting, and with the rotor blade 30 as the blade part, the oscillator 20 may be mounted on the rotor blade 30. The oscillator 20 may be mounted on both the rotor blade 30 and the stator blade 32. That is, in the first embodiment, the oscillator 20 may be mounted on at least either the rotor blade 30 or the stator blade 32 as the blade part. The mounting position of the oscillator 20 in the rotor blade 30 may be any position, and the position may be, for example, a position corresponding to the mounting position in the stator blade 32 in the first embodiment.

### Second Embodiment

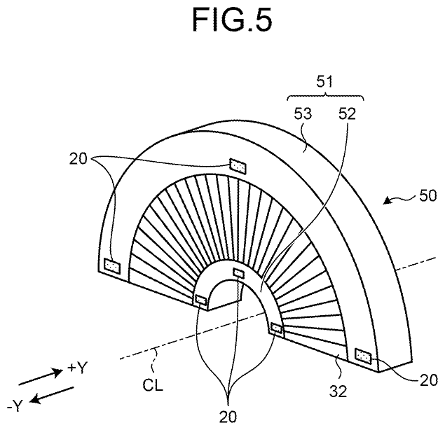

The following describes a second embodiment. In the first embodiment, the oscillator 20 is mounted inside the stator blade 32 to remove the scale on the blade surface, but in the second embodiment, the oscillator 20 is mounted on the blade ring 51, and thereby the scale on the blade surface can be removed. FIG. 5 is an overview diagram of the second embodiment. As illustrated in FIG. 5, in the second embodiment, the oscillator 20 is mounted on at least either the outer blade ring 53 or the inner blade ring 52 of the blade ring 51. In the example in FIG. 5, the oscillator 20 is mounted on both the outer blade ring 53 and the inner blade ring 52, but this is not limiting, and the oscillator 20 may be mounted on either the outer blade ring 53 or the inner blade ring 52. In the example in FIG. 5, three oscillators 20 are mounted on each of the outer blade ring 53 and the inner blade ring 52, but this is by way of example, and at least one oscillator 20 may be mounted on at least either the outer blade ring 53 or the inner blade ring 52. The second embodiment can also be applied to the first embodiment. That is, the oscillator 20 may be provided on the stator blade 32 and the oscillator 20 may be provided on at least either the outer blade ring 53 or the inner blade ring 52.

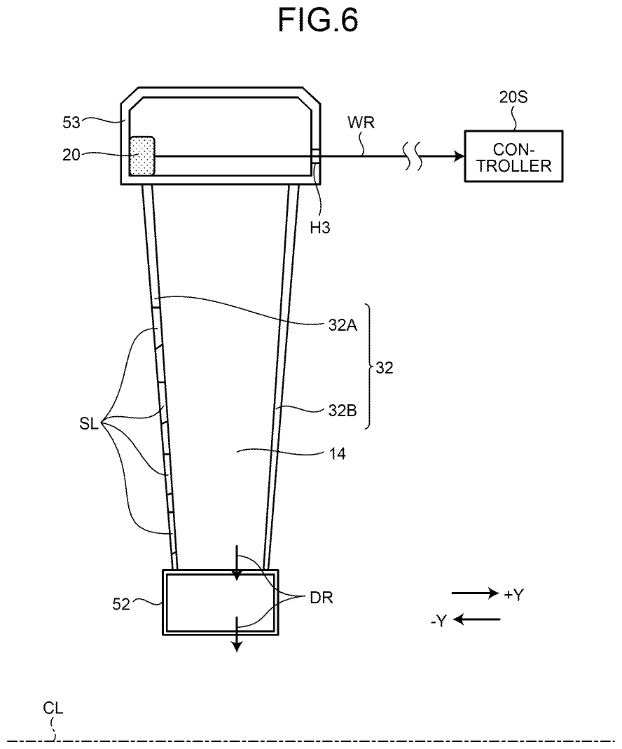

The following first describes an example of a case in which the oscillator 20 is provided in the outer blade ring 53. FIG. 6 is a sectional view of the stator blade 32 of Example 1 according to the second embodiment of the present disclosure. The functions and structures of the stator blade 32, the inner blade ring 52, the oscillator 20, and the controller 20S are the same as those of the first embodiment, and thus descriptions thereof are omitted. In Example 1 of the present embodiment, the oscillator 20 is mounted in the space inside the outer blade ring 53, and the electric wire WR is connected to the oscillator 20. The electric wire WR is drawn out to the space outside the internal casing 34 through an opening part H3 allowing the space inside the outer blade ring 53 and the space outside the internal casing 34 to communicate with each other and is connected to the controller 20S.

The oscillator 20 is mounted on the outer blade ring 53 by welding. Although the method of mounting is not limited to welding and may be any method, preferred is a method of mounting making the oscillator 20 and the stator blade 32 in direct contact with each other in order for the oscillator 20 to efficiently transmit the generated vibration to the stator blade 32. The position of the oscillator 20 is preferably, in the space inside the outer blade ring 53, a part close to upstream of the stator blade 32 (the ventral member 32A), to which much scale adheres.

### Effects

As described above, in the present example, the oscillator 20 mounted inside the outer blade ring 53 vibrates the outer blade ring 53, and consequently, the stator blade 32 connected to the outer blade ring 53 will also vibrate. Thus, according to the present embodiment, the scale adhering to the surface of the stator blade 32 can be removed. In addition, in the present embodiment, the number of oscillators 20 and the number of electric wires WR can be set to be smaller than those of the first embodiment.

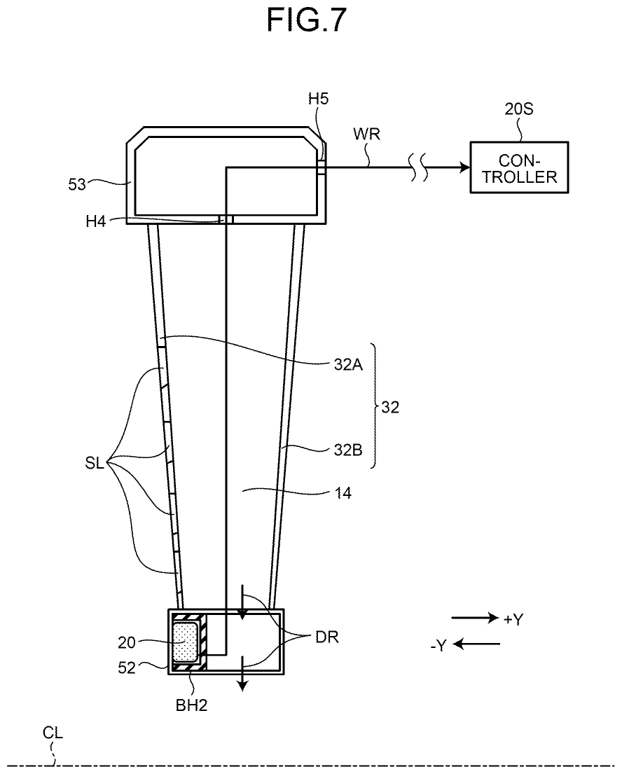

The following describes an example of a case in which the oscillator 20 is provided in the inner blade ring 52. FIG. 7 is a sectional view of the stator blade 32 according to Example 2 of the second embodiment of the present disclosure. The hollow part 14 and the space inside the outer blade ring 53 communicate with each other through an opening part H4, and the hollow part 14 and the space inside the inner blade ring 52 communicate with each other through the peripheries in contact with the inner blade ring 52 out of the ventral member 32A and the dorsal member 32B welded together. The space inside the inner blade ring 52 is provided with a bulkhead BH2 partitioning this space. The functions and structures of the stator blade 32, the oscillator 20, and the controller 20S are the same as those of the first embodiment, and thus descriptions thereof are omitted. In Example 2 of the present embodiment, the oscillator 20 is mounted inside the inner blade ring 52. Specifically, the oscillator 20 is mounted in the space partitioned by the bulkhead BH2 inside the inner blade ring 52. With this structure, the water DR having entered through the slits SL and then entered the inner blade ring 52 is blocked by the bulkhead BH2 and can be prevented from adhering to the oscillator 20.

The electric wire WR connected to the oscillator 20 is drawn into the hollow part 14 from the peripheries in contact with the inner blade ring 52 out of the ventral member 32A and the dorsal member 32B welded together. The electric wire WR is then drawn out to the space inside the outer blade ring 53 through the opening part H4 allowing the hollow part 14 and the space inside the outer blade ring 53 to communicate with each other, is further drawn out to the space outside the internal casing 34 through an opening part H5 allowing the space inside the outer blade ring 53 and the space outside the internal casing 34 to communicate with each other, and is connected to the controller 20S.

The oscillator 20 is mounted on the inner blade ring 52 by welding. Although the method of mounting is not limited to welding and may be any method, preferred is a method of mounting making the oscillator 20 and the stator blade 32 in direct contact with each other in order for the oscillator 20 to efficiently transmit the generated vibration to the stator blade 32. The position of the oscillator 20 is desirably, in the space inside the inner blade ring 52, a part close to upstream of the stator blade 32 (the ventral member 32A), to which much scale adheres.

### Effects

As described above, in the present example, the oscillator 20 mounted inside the inner blade ring 52 vibrates the inner blade ring 52, and consequently, the stator blade 32 welded to the inner blade ring 52 will also vibrate. Thus, according to the present embodiment, the scale adhering to the surface of the stator blade 32 can be removed. In addition, in the present embodiment, the number of oscillators 20 and the number of electric wires WR can be set to be smaller than those of the first embodiment.

### Third Embodiment

The following describes a third embodiment. The third embodiment differs from the first embodiment and the second embodiment in that the oscillator 20 is mounted on the internal casing 34. However, the third embodiment can be combined with the first embodiment and the second embodiment. That is, the oscillator 20 may be provided in the internal casing 34 and the oscillator 20 may be provided in at least one of the stator blade 32, the outer blade ring 53, and the inner blade ring 52.

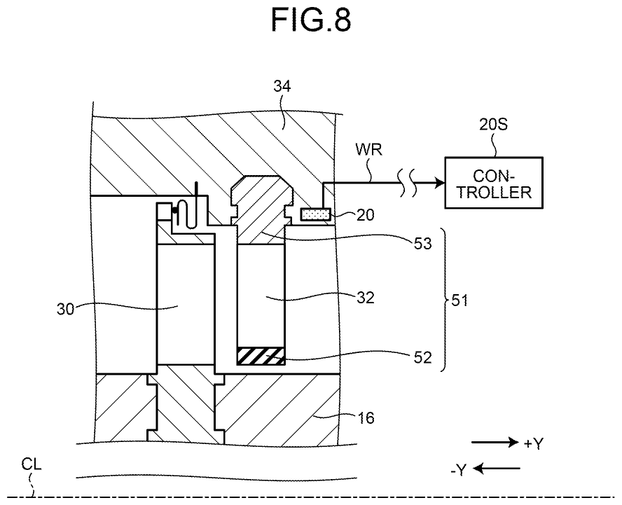

FIG. 8 is a sectional view of the casing in the steam turbine according to the third embodiment of the present disclosure. As illustrated in FIG. 8, the outer blade ring 53 and the oscillator 20 are mounted on the internal casing 34 of the steam turbine according to the third embodiment.

As in the stator blade 32, scale also adheres to the wall face of the internal casing 34, which is exposed to steam. In the steam turbine according to the third embodiment, the oscillator 20 is mounted inside the internal casing 34 (near a casing wall face) to vibrate the wall face of the internal casing 34. With this structure, the scale adhering to the wall face of the internal casing 34 can be removed.

The mounting position of the oscillator 20 in the internal casing 34 may be any position and the number of oscillators 20 mounted on the internal casing 34 may be any number. The number of oscillators 20 and the arrangement spacing between them may be freely changed while checking scale removal performance in the internal casing 34.

### Effects

As described above, in the third embodiment, the oscillator 20 mounted inside the internal casing 34 (near the casing wall face) vibrates the wall face of the internal casing 34. Thus, according to the present embodiment, the scale adhering to the wall face of the internal casing 34 can be removed.

### Effects

As described above, the turbine blade according to a first aspect of the present disclosure includes the blade part and the oscillator 20 mounted on the blade part and configured to vibrate the blade part. According to the present disclosure, by vibrating the blade part by the oscillator 20, the scale on the blade surface can be removed.

The turbine blade according to a second aspect of the present disclosure is the turbine blade according to the first aspect, in which the blade part is formed with the hollow part 14, and the oscillator 20 is mounted inside the hollow part 14. According to the present disclosure, the oscillator 20 mounted in the hollow part 14 of the blade part vibrates the blade, and thereby the scale on the blade surface can be removed.

The turbine blade according to a third aspect of the present disclosure is the turbine blade according to the first aspect, in which the turbine blade is the stator blade 32, and the blade part includes the blade (the stator blade 32) and the blade ring 51 supporting the blade. According to the present disclosure, the oscillator 20 mounted on the blade (the stator blade 32) or inside the blade ring 51 vibrates, and thereby the scale on the blade surface of the stator blade 32 can be removed.

The turbine blade according to a fourth aspect of the present disclosure is the turbine blade according to the third aspect, in which the oscillator 20 is mounted on the blade ring (the outer blade ring 53) provided outside the blade (the stator blade 32). According to the present disclosure, the oscillator 20 mounted on the outer blade ring 53 vibrates the outer blade ring 53 to vibrate the stator blade 32 welded to the outer blade ring 53, and thus the scale on the blade surface of the stator blade 32 can be removed. In addition, compared to the third aspect, the number of oscillators 20 and the number of electric wires WR leading to the oscillators 20 can be reduced.

The turbine blade according to a fifth aspect of the present disclosure is the turbine blade according to the third aspect, in which the oscillator 20 is mounted on the blade ring (the inner blade ring 52) provided inside the blade (the stator blade 32). According to the present disclosure, the oscillator 20 mounted on the inner blade ring 52 vibrates the inner blade ring 52 to vibrate the stator blade 32 welded to the inner blade ring 52, and thus the scale on the blade surface of the stator blade 32 can be removed. In addition, compared to the third aspect, the number of oscillators 20 and the number of electric wires WR leading to the oscillators 20 can be reduced.

The turbine blade according to a sixth aspect of the present disclosure is the turbine blade according to any one of the first aspect to the fifth aspect, in which the oscillator 20 can change the frequency at which the blade part is vibrated. According to the present disclosure, the oscillator 20 changes the frequency to change the positions of the nodes of the vibration mode on the blade and can remove the scale on the blade surface that corresponds to the nodes of the vibration mode on the blade and could not be removed by the vibration with a constant frequency.

The steam turbine 10 according to a seventh aspect of the present disclosure has the turbine blade according to any one of the first aspect to the fifth aspect. According to the present disclosure, the oscillator 20 vibrates the blade part (the stator blade unit 42). With this structure, the scale adhering to the blade surface can be removed.

The steam turbine 10 according to an eighth aspect of the present disclosure is the steam turbine according to the seventh aspect, including the oscillator 20, in the wall face of the turbine casing (the internal casing 34), configured to vibrate the wall face of the turbine casing (the inner car chamber 34). According A to the present disclosure, the oscillator 20 vibrates the blade surface and the wall face of the internal casing 34. With this structure, the scale adhering to the blade surface and the wall face of the internal casing 34 can be removed.

The embodiments of the present disclosure have been described, and the details of the embodiments do not limit embodiments. The components described above include ones that those skilled in the art can readily assume, substantially the same ones, and ones in what is called the range of equivalence. Further, the components described above can be combined with each other as appropriate. Further, various omissions, replacements, or modifications of the components can be made without departing from the gist of the embodiments described above.

### REFERENCE SIGNS LIST

10 STEAM TURBINE
14 HOLLOW PART
16 ROTOR
20 OSCILLATOR
20S CONTROLLER
30 ROTOR BLADE
32 STATOR BLADE
34 INTERNAL CASING
42 STATOR BLADE UNIT
51 BLADE RING
52 INNER BLADE RING
53 OUTER BLADE RING
10 CL ROTARY CENTRAL AXIS OF ROTOR 16
WR ELECTRIC WIRE
DR WATER

1. A turbine blade comprising:
a blade part; and
an oscillator mounted on the blade part to vibrate the blade part.

2. The turbine blade according to claim 1, wherein
the blade part is formed with a hollow part, and
the oscillator is mounted inside the hollow part.

3. The turbine blade according to claim 1, wherein
the turbine blade is a stator blade, and
the blade part includes a blade and a blade ring supporting the blade.

4. The turbine blade according to claim 3, wherein the oscillator is mounted on the blade ring provided outside the blade.

5. The turbine blade according to claim 3, wherein the oscillator is mounted on the blade ring provided inside the blade.

6. The turbine blade according to claim 1, wherein the oscillator is configured to change a frequency at which the blade part is vibrated.

7. A steam turbine comprising the turbine blade according to claim 1.

8. The steam turbine according to claim 7, comprising the oscillator, in a wall face of a turbine casing, configured to vibrate the wall face of the turbine casing.
